(19) United States
(12) Patent Application Publication
(10) Pub. No.: US 2021/0204756 A1
(43) Pub. Date: Jul. 8, 2021

(54) Grinder

(71) Applicant: Samson Bright Industrial Company Limited, Hong Kong (CN)

(72) Inventor: Yu Wing TANG, Hong Kong (CN)

(21) Appl. No.: 16/733,292

(22) Filed: Jan. 3, 2020

(51) Int. Cl. A47J 42/08; A47J 42/10; A47J 42/34; A47J 42/38; A47J 42/04

(52) U.S. Cl. CPC A47J 42/08; A47J 42/10; A47J 42/04; A47J 42/38; A47J 42/34

(57) ABSTRACT

A grinder has first and second body parts rotatable to each other. The first and second body parts engage the outer and inner burrs, respectively. A supporting flange in the second body part forms a seat to receive the outer burr. The outer burr is pressed toward the supporting flange to localize the outer burr against undesirable forces generated during grinding. A ring-shaped plate is sandwiched between the supporting flange and the outer burr. The outer burr presses on a bearing surface of the plate. The bearing surface is more resistant to abrasion than the supporting flange, advantageously reducing wear debris generation due to abrasion by the outer burr. Furthermore, a shaft engaging the inner burr is shaped as a triangular column for more effectively transmitting a received torque to the inner burr, allowing a plastic shaft to be used so as to reduce the manufacturing cost.

### FIELD OF THE INVENTION

The present invention relates to a grinder.

### BACKGROUND

A grinder is usually subject to heavy wear because a grinding burr in the grinder is usually in contact with other components of the grinder such that the grinding burr and the other components are abraded by each other during grinding operation, causing wear debris to fall out. The undesirable generation of wear debris is especially disadvantageous if the grinder is used for grinding edible food such as peppercorns, coffee beans and salt crystals.

As disclosed in CN204448154U, U.S. Pat. No. 7,648,094B2, DE202015002785U1, etc., one approach to reduce or even avoid wear debris to be generated from the grinding burr is to use a metallic burr or to coat a metallic layer on the grinding burr. However, the cost of manufacturing a grinder that employs a metallic or metal-reinforced burr is substantially increased when compared to using a ceramic burr. DE102015109726A1 discloses using health-acceptable plastics or ceramics to build the grinder in order to eliminate health hazard due to generation of unwanted wear debris during grinding. Although the wear debris is health-acceptable, the presence of wear debris in the food obtained after grinding still contaminates the food. DE102016106597B4 discloses a grinder designed to place frictional parts outside the chamber. Despite wear debris generated by the frictional parts does not fall into the food that is ground, a rotating grinding burr inside the chamber is required to be suspended by a rigid structure extended to outside the chamber. Furthermore, the rigid structure is required to precisely position the rotating grinding burr in order to avoid contacting with stationary components. The manufacturing cost of this grinder is generally not low.

There is a first need in the art for a grinder that avoids wear debris from dropping into the food obtained after grinding while the manufacturing cost of the grinder is kept low.

Another source of increasing the manufacturing cost is identified in driving the grinding burr. A shaft is used to engage the grinding burr so as to drive the grinding burr to rotate. The shaft is required to have sufficient mechanical strength; otherwise the shaft would be likely to prematurely break down. A metallic shaft is usually employed in the art, thereby increasing the material cost. It is desirable if a non-metallic shaft cheaper than the metallic can be used. It is even more desirable if the non-metallic shaft is a plastic shaft. The plastic shaft may be integrated with and incorporated into a body part of the grinder such that a one-step molding process can be used to form the body part that includes the shaft.

There is a second need in the art for a grinder that allows using a non-metallic shaft to drive the grinding burr and that is configured such that the shaft provides sufficient mechanical strength in driving the burr. Such grinder enables a reduction in manufacturing cost.

### SUMMARY OF THE INVENTION

A first aspect of the present invention is to provide a grinder for grinding solids into fine grains with advantages of avoiding wear debris from entering into the fine grains and avoiding installation of a rigid structure to suspend and precisely position grinding burrs in the grinder. The grinder may be advantageously used for grinding edible foods or condiments, and may also be used for grinding non-edible solids.

The grinder comprises an inner burr, an outer burr, a first body part, a second body part and a ring-shaped plate. The inner and outer burrs are collectively used for grinding the solids. The first body part engages the outer burr for driving the outer burr. The first body part comprises a locking member. The locking member is lockable to a complementary locking member. The locking member and the complementary locking member are configured to be mutually slidable when locked together. The second body part engages the inner burr for driving the inner burr. The second body part comprises the complementary locking member and a supporting flange. The supporting flange forms a seat for receiving the outer burr. Furthermore, the locking member and the complementary locking member are locked together. It causes the first and second body parts to be rotatable to each other to thereby produce a rotation between the inner and outer burrs for carrying out grinding. It also causes the outer burr to be pressed toward the supporting flange for forcibly maintaining a position of the outer burr on the supporting flange when grinding is carried out. The ring-shaped plate is sandwiched between the supporting flange and the outer burr. The ring-shaped plate comprises a bearing surface arranged to be pressed by the outer burr. The bearing surface is more resistant to abrasion done by the outer burr than the supporting flange is. Advantageously, it reduces a likelihood of wear debris generation due to abrasion by the outer burr.

In one embodiment, the bearing surface is made more resistant to abrasion than the supporting flange by forming the bearing surface to be less frictional than the supporting flange and by forming the ring-shaped plate with a material less brittle than another material that forms the supporting flange.

Preferably, the ring-shaped plate further comprises a second surface opposite to the bearing surface, where the second surface is more resistant to abrasion done by the outer burr than the supporting flange is.

The supporting flange may be made of polypropylene (PP). The ring-shaped plate may be made of polyethylene (PE). The outer and inner burrs may be made of ceramic.

The locking member and the complementary locking member may be a rim on the first body part and a groove on the second body part, respectively. Alternatively, it is possible that the locking member is a groove on the first body part and the complementary locking member is a rim on the second body part.

Preferably, the first body part comprises a first casing and an outer-burr holder. The first casing is used for enabling a user to hold the first body part while the user manually rotates the second body part. The first casing comprises the locking member. The outer-burr holder engages the outer burr at a periphery thereof for directly driving the outer burr. The outer-burr holder is rigidly coupled to the first casing for securely locking the first casing to the outer-burr holder. In one embodiment, the first casing further comprises a first plurality of teeth, and the outer-burr holder further comprises a second plurality of teeth for engaging with the first plurality of teeth so as to rigidly couple the first casing to the outer-burr holder.

The first casing and the outer-burr holder may be made of PP.

The first body part may further comprise an openable cover installed on the first casing for releasing the fine grains.

Preferably, the second body part comprises a second casing, a shaft and a linking mechanism. The second casing comprises the complementary locking member. The shaft is centrally disposed in the second body part for engaging with the inner burr. The linking mechanism is used for rigidly connecting the shaft to the second casing. In one embodiment, the linking mechanism comprises plural beams each connecting the shaft to the second casing. The beams may be located on a plane perpendicular to the shaft.

It is preferable that the grinder further comprises a helical spring and a bushing. Particularly, the bushing mates with the shaft. The inner burr is formed with a hole such that the shaft passes through the hole to engage the inner burr and to mate with the bushing. The helical spring is inserted into the shaft for exerting a force to push the inner burr toward the bushing. In addition, the first body part includes a stopper for backing the bushing and pressing the bushing against the force exerted by the helical spring so as to localize the inner burr along the shaft. The bushing is attached to the stopper.

Preferably, the shaft is shaped as a triangular column for more effectively transmitting a torque received by the second casing to the inner burr when compared to using another shaft shaped as a circular or rectangular column. Correspondingly, the hole in the inner burr is a triangular one for receiving the shaft.

In one embodiment, the bushing is controllably movable toward and away from the helical spring so as to move the inner burr to and fro along the shaft to adjust a relative position between the inner and outer burrs. Thereby, it allows a grain size of the fine grains to be selectable when the grinder is used to grind the solids into the fine grains.

In one embodiment, the second casing, the shaft and the linking mechanism are integrally formed in the second body part. The second casing, the shaft and the linking mechanism may be made of PP.

In one embodiment, a screw thread is formed on the second body part for engaging with an external container.

A second aspect of the present invention is to provide a grinder for grinding solids into fine grains, with a potential of using a non-metallic shaft to drive an inner burr in the grinder while the non-metallic shaft is configured to have sufficient mechanical strength in driving the inner burr. Thereby, the cost of manufacturing the grinder may be reduced.

The grinder comprises an inner burr, an outer burr, a first body part and a second body part. The inner and outer burrs are collectively used for grinding. The first body part engages the outer burr for driving the outer burr. The second body part engages the inner burr for driving the inner burr. The first and second body parts are rotatable to each other to thereby produce a rotation between the inner and outer burrs for carrying out grinding. The second body part comprises a second casing, a shaft and a linking mechanism. The shaft is centrally disposed in the second body part for engaging with the inner burr. The linking mechanism is used for rigidly connecting the shaft to the second casing. In particular, the shaft is shaped as a triangular column for more effectively transmitting a torque received by the second casing to the inner burr when compared to using another shaft shaped as a circular or rectangular column.

Preferably, the inner burr is formed with a triangular hole for receiving the shaft.

In one embodiment, the linking mechanism comprises plural beams each connecting the shaft to the second casing. The beams may be located on a plane perpendicular to the shaft.

In one embodiment, the grinder may further comprise a helical spring and a bushing. The bushing mates with the shaft. The inner burr is formed with a hole such that the shaft passes through the hole to engage the inner burr and to mate with the bushing. The helical spring is inserted into the shaft for exerting a force to push the inner burr toward the bushing. The first body part includes a stopper for backing the bushing and pressing the bushing against the force exerted by the helical spring so as to localize the inner burr along the shaft. The bushing is attached to the stopper.

The bushing may be controllably movable toward and away from the helical spring so as to move the inner burr to and fro along the shaft to adjust a relative position between the inner and outer burrs, thereby allowing a grain size to be selectable when the grinder is used to grind solids into fine grains.

The second casing, the shaft and the linking mechanism may be integrally formed in the second body part.

The second casing, the shaft and the linking mechanism may be made of PP.

Other aspects of the present invention are disclosed as illustrated by the embodiments hereinafter.

### BRIEF DESCRIPTION OF THE DRAWINGS

FIG. 1 depicts a perspective view of a grinder in accordance with an exemplary embodiment of the present invention.

FIG. 2 depicts a side view of the grinder of FIG. 1.

FIG. 3 depicts a cross-sectional view of the grinder of FIG. 1, showing an internal structure thereof.

FIG. 4 depicts an exploded view of the grinder of FIG. 1.

### DETAILED DESCRIPTION

As used herein in the specification and appended claims, the term “avoid” or “avoiding” refers to any method to partially or completely preclude, avert, obviate, forestall, stop, hinder or delay the consequence or phenomenon following the term “avoid” or “avoiding” from happening. The term “avoid” or “avoiding” does not mean that the method is necessarily absolute, but rather effective for providing some degree of avoidance or prevention or amelioration of consequence or phenomenon following the term “avoid” or “avoiding”.

A first aspect of the present invention is to provide a grinder for grinding solids into fine grains where the grinder has the following advantages. The grinder is configured to avoid wear debris from dropping into the fine grains. Furthermore, the grinder is designed not to include a rigid structure for suspending and precisely positioning any burr inside the grinder in order to keep the manufacturing cost low. The disclosed grinder is particularly useful for grinding edible foods and condiments, such as beans, peas, coffee beans, peppercorns and salt crystals. Nevertheless, the disclosed grinder is not limited only to grinding edible foods and condiments; the disclosed grinder is also applicable for grinding non-food solids.

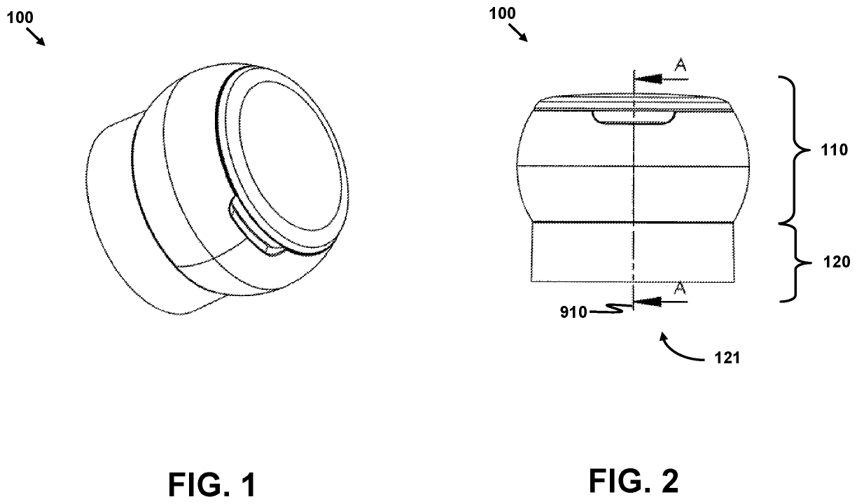

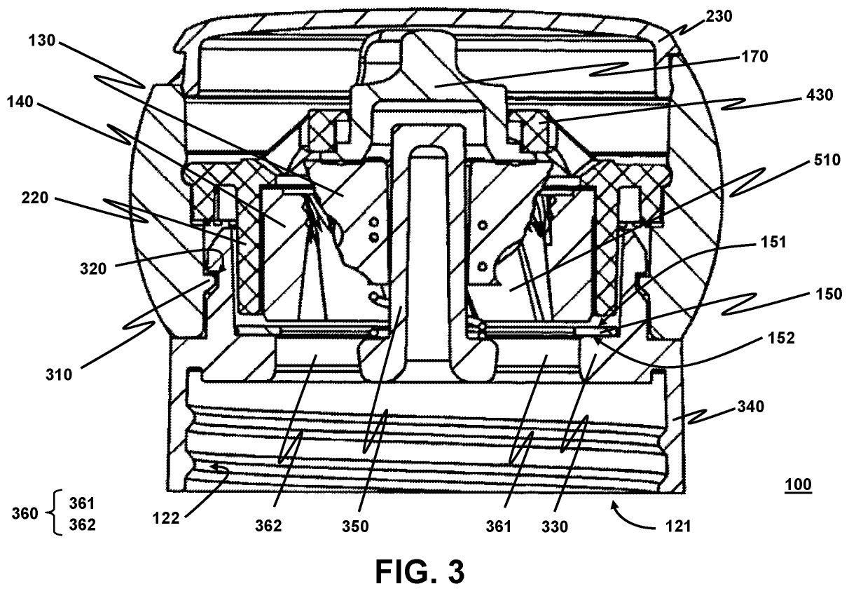

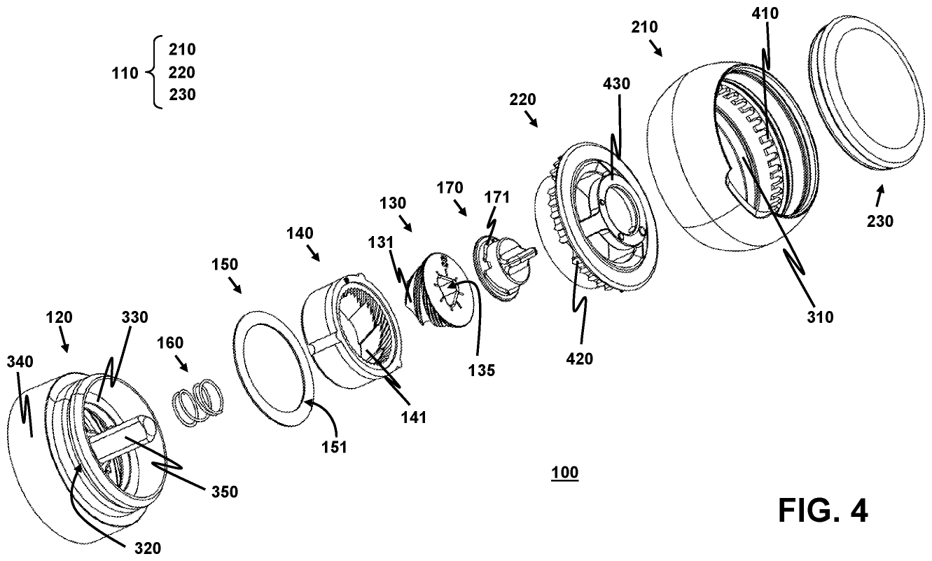

The disclosed grinder is exemplarily illustrated hereinafter with the aid of FIGS. 1-4. FIG. 1 depicts a perspective view of a grinder 100 in accordance with an exemplary embodiment of the present invention. FIG. 2 illustrates a side view of the grinder 100. FIG. 3 depicts a cross-sectional view of the grinder 100 for section AA 910 shown in FIG. 2. FIG. 4 depicts an exploded view of the grinder 100 that is shown in FIG. 1.

The grinder 100 according to the first aspect of the present invention comprises an inner burr 130 and an outer burr 140 collectively used for grinding the solids. The inner burr 130 is usually shaped as a truncated cone with grinding teeth 131 formed on a lateral side of the inner burr 130. Typically, the outer burr 140 has a shape of a tube, with grinding teeth 141 formed on an interior surface of the tube. In the grinder 100, at least part of the inner burr 130 resides inside the outer burr 140. Usually, a substantial part of the inner burr 130, or the whole inner burr 130, resides in the outer burr 140. A chamber 510 (shown in FIG. 3) is formed by the inner and outer burrs 130, 140, where the solids are ground inside the chamber 510 to form the fine grains. Apart from the inner burr 130 and the outer burr 140 as disclosed above, other designs of the pair of burrs, such as the designs disclosed in U.S. Pat. No. 9,578,989B2 and CN2572897Y, may also be used. The inner and outer burrs 130, 140 may be made of ceramic for utilizing its low-cost advantage.

The grinder 100 further comprises a first body part 110 and a second body part 120 engaged together and rotatable to each other. The combination of the first and second body parts 110, 120 forms a grinder body.

The first body part 110 engages the outer burr 140 for driving the outer burr 140. The second body part 120 engages the inner burr 130 for driving the inner burr 130. The first body part 110 comprises a locking member 310 and the second body part 120 comprises a complementary locking member 320. The locking member 310 is lockable to the complementary locking member 320. In addition, the locking member 310 and the complementary locking member 320 are configured to be mutually slidable when the locking member 310 and the complementary locking member 320 are locked together. (Examples of the two locking members 310, 320 that are mutually slidable are given below.) During manufacturing the grinder 100, the first and second body parts 110, 120 are separately formed and then assembled together by engaging the locking member 310 with the complementary locking member 320. As a finished product, the grinder 100 has the locking member 310 and the complementary locking member 320 locked together. As a result, the first and second body parts 110, 120 are caused to be rotatable to each other to thereby produce a rotation between the inner and outer burrs 130, 140 for carrying out grinding. The second body part 120 further comprises a supporting flange 330. The supporting flange 330 forms a seat for receiving the outer burr 140. The outer burr 140 is judiciously positioned in the grinder 100 in order that locking the locking member 310 and the complementary locking member 320 together causes the outer burr 140 to be pressed toward the supporting flange 330 for forcibly maintaining a position of the outer burr 140 on the supporting flange 330 when grinding the solids is carried out. Thus, the outer burr 140 is advantageously localized against undesirable forces generated during grinding the solids. A rigid structure is not required to firmly hold and precisely position the outer burr 140 against the undesirable forces, leading to a reduction in manufacturing cost.

In one embodiment, as shown in FIG. 3, the locking member 310 is a rim on the first body part 110 and the complementary locking member 320 is a groove on the second body part 120. The rim and the groove are formed with smooth surfaces for reducing sliding friction between the rim and the groove so as to enable the locking member 310 and the complementary locking member 320 to be mutually slidable. In another embodiment not shown in FIG. 3, the locking member 310 is a groove on the first body part 110 and the complementary locking member 320 is a rim on the second body part 120. Similarly, the rim and the groove are formed with smooth surfaces. Apart from the rim and groove, other choices of the locking member 310 and the complementary locking member 320 may be used. For example, nose-like projections as disclosed in DE102016106597B4 may be formed on the first and second body parts 110, 120 to be used as the locking member 310 and the complementary locking member 320.

Advantageously, the grinder 100 further comprises a ring-shaped plate 150 sandwiched between the supporting flange 330 and the outer burr 140. The ring-shaped plate 150 comprises a bearing surface 151 arranged to be pressed by the outer burr 140. In particular, the bearing surface 151 is more resistant to abrasion than the supporting flange 330, where the abrasion is done by the outer burr 140. It reduces a likelihood of wear debris generation due to abrasion by the outer burr 140.

In one embodiment, the bearing surface is made more resistant to abrasion than the supporting flange 330 by (1) forming the bearing surface 151 to be less frictional than the supporting flange 330, and (2) forming the ring-shaped plate 150 with a material less brittle than another material that forms the supporting flange 330. By this approach, one may select PP to form the supporting flange 330 and PE to form the ring-shaped plate 150. Note that the second body part 120 is usually formed with the supporting flange 330 as one integrated unit. In this case, the whole second body part 120 may be made of PP. Other appropriate materials for forming the ring-shaped plate 150 are possible, e.g., low-friction low-wear polymers and polymer composites as disclosed in U.S. Pat. No. 7,314,646B2.

The ring-shaped plate 150 has the bearing surface 151 facing the outer burr 140, and a second surface 152 facing the supporting flange 330. The second surface 152 is opposite to the bearing surface 151. Preferably, both the bearing surface 151 and the second surface 152 are more resistant to abrasion than the supporting flange 330. During assembling the grinder 100, it is possible that the ring-shaped plate 150 is mis-oriented due to error such that the bearing surface 151 originally intended to face the outer burr 140 actually faces the supporting flange 330. The advantage of having both the bearing surface 151 and the second surface 152 to be abrasion-resistant is evident.

In practical situations, the grinder 100 is usually attached to an external container at an end 121 of the second body part 120. A screw thread 122 may be formed on the second body part 120 for engaging with the container. The container is used to store the solids, such as peppercorns, to be ground. When the user wishes to grind the solids, the user turns the grinder 100 integrated with the container upside down to let the solids fall into the grinder 100. Usually and conveniently, the user holds the first body part 110 and rotates the second body part 120 (via rotating the container) to grind the solids into the fine grains.

In one advantageous realization of the grinder 100, the first body part 110 further comprises a first casing 210 and an outer-burr holder 220, where the first casing 210 comprises the locking member 310. The first casing 210 enables the user to hold the first body part 110 while manually rotating the second body part 120. The outer-burr holder 220 engages the outer burr 140 at a periphery thereof for directly driving the outer burr 140. The outer-burr holder 220 is rigidly coupled to the first casing 210. To achieve the rigid coupling between the first casing 210 and the outer-burr holder 220, it is preferable that the first casing 210 further comprises a first plurality of teeth 410, and that the outer-burr holder 220 further comprises a second plurality of teeth 420 for engaging with the first plurality of teeth 410. The first and second pluralities of teeth 410, 420 altogether enable the first casing 210 and the outer-burr holder 220 to be easily assembled during manufacturing the second body part 120 while providing rigid coupling between the first casing 210 and the outer-burr holder 220. To reduce the material cost, the first casing 210 and the outer-burr holder 220 may be made of PP. It is possible that the first casing 210 and the outer-burr holder 220 are separately formed and then assembled together. It is also possible that the first casing 210 and the outer-burr holder 220 are directly formed as one integrated unit.

Preferably, the first body part 110 further comprises an openable cover 230 installed on the first casing 210 for releasing the fine grains.

In the grinder 100, grinding the solids is done inside the chamber 510. As shown in FIG. 3, the locking member 310 and the complementary locking member 320 are located outside the chamber 510. The path leading from the locking member 310 and the complementary locking member 320 to the chamber 510 is sealed off by the outer-burr holder 220. Advantageously, possible wear debris formed by motion between the locking member 310 and the complementary locking member 310 does not enter into the chamber 510 to contaminate the fine grains.

Regarding the second body part 120, preferably the second body part 120 further comprises a second casing 340, a shaft 350 and a linking mechanism 360. The second casing 340 comprises the complementary locking member 320. The shaft 350 is centrally disposed in the second body part 120 for engaging with the inner burr 130. The linking mechanism 360 is used for rigidly connecting the shaft 350 to the second casing 340. In one embodiment, the linking mechanism 360 comprises plural beams 361, 362 each connecting the shaft 350 to the second casing 340. (Although two beams 361, 362 are depicted in FIG. 3 for illustration, the total number of the beams in the linking mechanism 360 may be any number greater than one, e.g., three or four.) The beams 361, 362 may be located on a plane perpendicular to the shaft 350. During manufacturing of the second body part 120, the second casing 340, the shaft 350 and the linking mechanism 360 may be integrally formed to give an integrated unit. Optionally, the integrated unit may form the whole second body part 120. The second casing 340, the shaft 350 and the linking mechanism 360 may also be made of PP for its low-cost advantage.

It is desirable that the inner burr 130 is firmly engaged with the shaft 350 such that the inner burr 130 is localized at a certain position on the shaft 350. It is achievable by using a helical spring 160, a bushing 170 and a stopper 430. The stopper 430 is a part of the outer-burr holder 220. The bushing 170, being a smooth walled bearing, mates with the shaft 350. The inner burr 130 is formed with a hole 135 such that the shaft 350 passes through the hole 135 to engage the inner burr 130 and to mate with the bushing 170. The helical spring 160 is inserted into the shaft 350 for exerting a force to push the inner burr 130 toward the bushing 170. The bushing 170 is attached to, or mounted to, or fixed at, the stopper 430. The stopper 430 backs the bushing 170 and presses the bushing 170 against the force exerted by the helical spring 160 so as to localize the inner burr 130 along the shaft 350. Since the bushing 170 slidably contacts the inner burr 130 and the shaft 350 when the second body part 120 rotates relative to the first body part 110, preferably the bushing 170 has a surface that is smooth and less frictional.

In one embodiment, the engagement between the inner burr 130 and the shaft 350 is further strengthened by shaping the shaft 350 as a triangular column. As a result, the inner burr 130 is more securely locked to the shaft 350 and the shaft 350 is more effective to transmit a torque received by the second casing 340 to the inner burr 130 when compared to using another shaft shaped as a circular or rectangular column. To make the inner burr 130 engage the shaft 350, the hole 135 formed in the inner burr 130 is shaped as a triangular hole for receiving the shaft 350.

The grinder 100 may be further configured to allow the user to choose a grain size of the fine grains produced by grinding. The grain size is changeable by changing a separation between the inner burr 130 and the outer burr 140 where the separation is measured at a location at which the fine grains leave the outer burr 140 or the inner burr 130, whichever earlier. Hence, the grain size is adjustable by adjusting the position of the inner burr 130 localized on the shaft 350. In one embodiment, it is achieved by including a track 171 on the bushing 170. The track 171 may be formed as a protruded path on an exterior surface of the bushing 170. The track 171 is in contact with the stopper 430 and is used to guide the bushing 170 to move close to or move away from the stopper 430 for a certain small distance. As a result, the bushing 170 is controllably movable toward and away from the helical spring 160 so as to move the inner burr 130 to and fro along the shaft 350 to adjust a relative position between the inner burr 130 and the outer burr 140. Thereby, the grain size is adjustable or selectable.

A second aspect of the present invention is to provide a grinder for grinding solids into fine grains, with a potential of using a non-metallic shaft to drive an inner burr in the grinder while the non-metallic shaft is configured to have sufficient mechanical strength in driving the inner burr. The grinder thereby gives an advantage that its manufacturing cost may be kept low.

The approach used herein in the present invention to increase the mechanical strength of the shaft is to appropriately shape the shaft. Although this increase is particularly advantageous in realizing the shaft that uses a non-metallic material less expensive than a metal, the present invention is not limited only to the case that the shaft used for driving the inner burr is non-metallic; the disclosed grinder may employ a metallic shaft in driving the inner burr.

Although the grinder is particularly useful for grinding edible foods and condiments, the disclosed grinder is not limited only to grinding edible foods and condiments; the disclosed grinder is also applicable for grinding non-food solids.

A non-metallic shaft may be formed with a mechanically strong material such that sufficient mechanical strength may be provided to drive the inner burr. However, this approach is likely to defeat the aim of keeping the manufacturing cost low. Alternatively, as is advantageously used in the present invention, the engagement between the inner burr and the shaft may be strengthened by judiciously shaping the shaft. In this regard, the shaft is advantageously shaped as a triangular column. By using the triangularly shaped shaft, the inner burr is more securely locked to the shaft so that the shaft is more effective in transmitting a torque to the inner burr when compared to using another shaft shaped as a circular or rectangular column.

The disclosed grinder is described and explained also with the aid of FIGS. 1-4. The disclosed grinder according to the second aspect of the present invention (also referenced as the grinder 100 for convenience) comprises an inner burr 130, an outer burr 140, a first body part 110 and a second body part 120. The inner burr 130 and the outer burr 140 are collectively used for grinding. The first body part 110 engages the outer burr 140 for driving the outer burr 140. The second body part 120 engages the inner burr 130 for driving the inner burr 130. The first body part 110 and the second body part 120 are engaged together and are rotatable to each other. When the second body part 120 is driven, e.g. by a user, to rotate with respect to the first body part 110, a rotation between the inner and outer burrs is thereby produced for carrying out grinding. The second body part comprises: a second casing 340; a shaft 350 centrally disposed in the second body part 120 for engaging with the inner burr 130; and a linking mechanism 360 for rigidly connecting the shaft 350 to the second casing 340. Advantageously, the shaft 350 is shaped as a triangular column for more effectively transmitting a torque received by the second casing 340 to the inner burr 130 when compared to using another shaft shaped as a circular or rectangular column.

In one embodiment, the linking mechanism 360 comprises plural beams 361, 362 each connecting the shaft 350 to the second casing 340. (Although two beams 361, 362 are depicted in FIG. 3 for illustration, the total number of the beams in the linking mechanism 360 may be any number greater than one, e.g., three or four.) The beams 361, 362 may be located on a plane perpendicular to the shaft 350. During manufacturing of the second body part 120, the second casing 340, the shaft 350 and the linking mechanism 360 may be integrally formed to give an integrated unit. Optionally, the integrated unit may form the whole second body part 120. The second casing 340, the shaft 350 and the linking mechanism 360 may also be made of PP for its low-cost advantage.

It is desirable that the inner burr 130 is firmly engaged with the shaft 350 such that the inner burr 130 is localized at a certain position on the shaft 350. It is achievable by using a helical spring 160, a bushing 170 and a stopper 430. The stopper 430 is a part of the first body part 110 and is integrated therein. The bushing 170, being a smooth walled bearing, mates with the shaft 350. The inner burr 130 is formed with a hole 135 such that the shaft 350 passes through the hole 135 to engage the inner burr 130 and to mate with the bushing 170. To make the inner burr 130 engage the shaft 350, preferably the hole 135 formed in the inner burr 130 is shaped as a triangular hole for receiving the shaft 350. The helical spring 160 is inserted into the shaft 350 for exerting a force to push the inner burr 130 toward the bushing 170. The bushing 170 is attached to, or mounted to, or fixed at, the stopper 430. The stopper 430 backs the bushing 170 and presses the bushing 170 against the force exerted by the helical spring 160 so as to localize the inner burr 130 along the shaft 350. Since the bushing 170 slidably contacts the inner burr 130 and the shaft 350 when the second body part 120 rotates relative to the first body part 110, preferably the bushing 170 has a surface that is smooth and less frictional.

Although two grinders have been separately elaborated for the first and second aspects of the present invention, a grinder may be formed by including plural features each originated from either the first aspect of the present invention or the second aspect.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A grinder comprising:
an inner burr and an outer burr collectively used for grinding;
a first body part engaging the outer burr for driving the outer burr, the first body part comprising a locking member, the locking member being lockable to a complementary locking member, the locking member and the complementary locking member being configured to be mutually slidable when locked together;
a second body part engaging the inner burr for driving the inner burr, the second body part comprising the complementary locking member and a supporting flange, the supporting flange forming a seat for receiving the outer burr, wherein the locking member and the complementary locking member are locked together, causing the first and second body parts to be rotatable to each other to thereby produce a rotation between the inner and outer burrs for carrying out grinding, and causing the outer burr to be pressed toward the supporting flange for forcibly maintaining a position of the outer burr on the supporting flange when grinding is carried out; and
a ring-shaped plate sandwiched between the supporting flange and the outer burr, the ring-shaped plate comprising a bearing surface arranged to be pressed by the outer burr, wherein the bearing surface is more resistant to abrasion done by the outer burr than the supporting flange is.

2. The grinder of claim 1, wherein the bearing surface is made more resistant to abrasion than the supporting flange by forming the bearing surface to be less frictional than the supporting flange and by forming the ring-shaped plate with a material less brittle than another material that forms the supporting flange.

3. The grinder of claim 1, wherein the ring-shaped plate further comprises a second surface opposite to the bearing surface, the second surface being more resistant to abrasion than the supporting flange.

4. The grinder of claim 1, wherein:
the supporting flange is made of polypropylene (PP); and
the ring-shaped plate is made of polyethylene (PE).

5. The grinder of claim 1, wherein the locking member is a rim on the first body part and the complementary locking member is a groove on the second body part.

6. The grinder of claim 1, wherein the locking member is a groove on the first body part and the complementary locking member is a rim on the second body part.

7. The grinder of claim 1, wherein the outer and inner burrs are made of ceramic.

8. The grinder of claim 1, wherein the first body part comprises:
a first casing for enabling a user to manually hold the first body part while the user rotates the second body part, the first casing comprising the locking member; and
an outer-burr holder engaging the outer burr at a periphery thereof for directly driving the outer burr, the outer-burr holder being rigidly coupled to the first casing for securely locking the first casing to the outer-burr holder.

9. The grinder of claim 8, wherein:
the first casing further comprises a first plurality of teeth; and
the outer-burr holder further comprises a second plurality of teeth for engaging with the first plurality of teeth so as to rigidly couple the first casing to the outer-burr holder.

10. The grinder of claim 8, wherein the first casing and the outer-burr holder are made of polypropylene (PP).

11. The grinder of claim 8, wherein the first body part further comprises an openable cover installed on the first casing for releasing fine grains when the grinder is used to grind solids into the fine grains.

12. The grinder of claim 1, wherein the second body part comprises:
a second casing comprising the complementary locking member;
a shaft centrally disposed in the second body part for engaging with the inner burr; and
a linking mechanism for rigidly connecting the shaft to the second casing.

13. The grinder of claim 12, wherein the linking mechanism comprises plural beams each connecting the shaft to the second casing.

14. The grinder of claim 13, wherein the beams are located on a plane perpendicular to the shaft.

15. The grinder of claim 12, wherein:
the shaft is shaped as a triangular column for more effectively transmitting a torque received by the second casing to the inner burr when compared to using another shaft shaped as a circular or rectangular column; and
the inner burr is formed with a triangular hole for receiving the shaft.

16. The grinder of claim 12 further comprising a helical spring and a bushing, wherein:
the bushing mates with the shaft;
the inner burr is formed with a hole such that the shaft passes through the hole to engage the inner burr and to mate with the bushing;
the helical spring is inserted into the shaft for exerting a force to push the inner burr toward the bushing;
the first body part includes a stopper for backing the bushing and pressing the bushing against the force exerted by the helical spring so as to localize the inner burr along the shaft; and
the bushing is attached to the stopper.

17. The grinder of claim 16, wherein the bushing is controllably movable toward and away from the helical spring so as to move the inner burr to and fro along the shaft to adjust a relative position between the inner and outer burrs, thereby allowing a grain size to be selectable when the grinder is used to grind solids into fine grains.

18. The grinder of claim 12, wherein the second casing, the shaft and the linking mechanism are integrally formed in the second body part.

19. The grinder of claim 12, wherein the second casing, the shaft and the linking mechanism are made of polypropylene (PP).

20. The grinder of claim 1, wherein a screw thread is formed on the second body part for engaging with an external container.

21. A grinder comprising:
an inner burr and an outer burr collectively used for grinding;
a first body part engaging the outer burr for driving the outer burr; and
a second body part engaging the inner burr for driving the inner burr, the first and second body parts being rotatable to each other to thereby produce a rotation between the inner and outer burrs for carrying out grinding, the second body part comprising:
a second casing;
a shaft centrally disposed in the second body part for engaging with the inner burr; and
a linking mechanism for rigidly connecting the shaft to the second casing;
wherein the shaft is shaped as a triangular column for more effectively transmitting a torque received by the second casing to the inner burr when compared to using another shaft shaped as a circular or rectangular column.

22. The grinder of claim 21, wherein the inner burr is formed with a triangular hole for receiving the shaft.

23. The grinder of claim 21, wherein the linking mechanism comprises plural beams each connecting the shaft to the second casing.

24. The grinder of claim 23, wherein the beams are located on a plane perpendicular to the shaft.

25. The grinder of claim 21 further comprising a helical spring and a bushing, wherein:
the bushing mates with the shaft;
the inner burr is formed with a hole such that the shaft passes through the hole to engage the inner burr and to mate with the bushing;
the helical spring is inserted into the shaft for exerting a force to push the inner burr toward the bushing;
the first body part includes a stopper for backing the bushing and pressing the bushing against the force exerted by the helical spring so as to localize the inner burr along the shaft; and
the bushing is attached to the stopper.

26. The grinder of claim 25, wherein the bushing is controllably movable toward and away from the helical spring so as to move the inner burr to and fro along the shaft to adjust a relative position between the inner and outer burrs, thereby allowing a grain size to be selectable when the grinder is used to grind solids into fine grains.

27. The grinder of claim 21, wherein the second casing, the shaft and the linking mechanism are integrally formed in the second body part.

28. The grinder of claim 21, wherein the second casing, the shaft and the linking mechanism are made of polypropylene (PP).
